(19) United States
(12) Patent Application Publication
(10) Pub. No.: US 2017/0351167 A1
(43) Pub. Date: Dec. 7, 2017

(54) PROJECTION SYSTEM AND ILLUMINATION SYSTEM

(71) Applicant: Coretronic Corporation, Hsin-Chu (TW)

(72) Inventors: Hsuan-I Wu, Hsin-Chu (TW); Chi-Hsun Wang, Hsin-Chu (TW); Hao-Wei Chiu, Hsin-Chu (TW); Ko-Shun Chen, Hsin-Chu (TW)

(21) Appl. No.: 15/610,322

(22) Filed: May 31, 2017

(30) Foreign Application Priority Data
Jun. 2, 2016 (CN) 201610388177.2

(51) Int. Cl. G03B 21/20; F21V 7/00

(52) U.S. Cl. CPC G03B 21/2066; G03B 21/2033; F21V 7/0066; G03B 21/2013

(57) ABSTRACT

An illumination system of a projection system includes a first illumination integrating element, a second illumination integrating element, first light source elements, and second light source elements. The first/second illumination integrating element includes first/second light-reflecting regions separated from each other and located on a first/second plane. The second plane is not parallel to the first plane. The first/second light source elements are adapted to provide first/second light beams respectively. The first/second light-reflecting regions are located on a transmission path of the first/second light beams, and the first/second light beams are adapted to travel along the illumination direction after being reflected by the first/second light-reflecting regions. The illumination system has good optical quality. The projection system has good image quality.

### CROSS-REFERENCE TO RELATED APPLICATION

This application claims the priority benefit of CN201610388177.2, filed on 2016 Jun. 2. The entirety of the above-mentioned patent application is hereby incorporated by reference herein and made a part of this specification.

### FIELD OF THE INVENTION

The present invention relates to an illumination system, and more particular to an illumination system applied to a projector system.

### BACKGROUND OF THE INVENTION

Currently, the proportion of projectors using light sources such as laser in high-end projector market is increasing, and at the same time, there is growing demand for high brightness. In order to achieve higher brightness, adding more light sources inside the projector is a necessary trend. Due to restrictions on the arrangement of light sources, the light source elements will be grouped and arranged in two different directions, and then light beams illuminated from the light source elements are combined together by a light combiner element and then imported to a projector light combining system. With all the different models, the institutional design is limit by the overall size of the housing, and therefore face many problems: 1. structures and production methods of illumination systems are complex; 2. higher production costs; and 3. larger process tolerances.

The information disclosed in this “BACKGROUND OF THE INVENTION” Section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The invention provides a projection system, which may have good image quality.

The invention further provides an illumination system, which may have good optical quality.

Other advantages and objects of the invention may be further illustrated by the technical features broadly embodied and described as follows.

In order to achieve one or a portion of or all of the objects or other objects, an embodiment of the invention provides a projection system including an illumination system, a light valve, and a projection lens. The illumination system is adapted to provide an illumination beam, and includes a first illumination integrating element, a second illumination integrating element, a plurality of first light source elements, and a plurality of second light source elements. The first illumination integrating element includes a plurality of first light-reflecting regions separated from each other and located on a first plane. The second illumination integrating element includes a plurality of second light-reflecting regions separated from each other and located on a second plane. The second plane is not parallel to the first plane. The first light source elements are adapted to provide a plurality of first light beams respectively. The first light-reflecting regions are located on a transmission path of the first light beams, and the first light beams are adapted to travel along the illumination direction after being reflected by the first light-reflecting regions. The second light source elements are adapted to provide a plurality of second light beams respectively. The second light-reflecting regions are located on a transmission path of the second light beams, and the second light beams are adapted to travel along the illumination direction after being reflected by the second light-reflecting regions. The illumination beam includes the first light beams and the second light beams from the first illumination integrating element and the second illumination integrating element. The light valve is located on a transmission path of the illumination beam, and adapted to convert the illumination beam into an image beam. The projection lens is located on a transmission path of the image beam.

An embodiment of the invention also provides an illumination system, and the illumination system is adapted to provide an illumination beam. The illumination system includes a first illumination integrating element, a second illumination integrating element, a plurality of first light source elements, and a plurality of second light source elements. The first illumination integrating element includes a plurality of first light-reflecting regions, wherein the first light-reflecting regions are separated from each other and located on a first plane. The second illumination integrating element includes a plurality of second light-reflecting regions, wherein the second light-reflecting regions are separated from each other and located on a second plane. The second plane is not parallel to the first plane. The first light source elements are adapted to provide a plurality of first light beams, respectively. The first light-reflecting regions are located on a transmission path of the first light beams, and the first light beams are adapted to travel along an illumination direction after being reflected by the first light-reflecting regions. The second light source elements are adapted to provide a plurality of second light beams, respectively, wherein the second light-reflecting regions are located on a transmission path of the second light beams, and the second light beams are adapted to travel along the illumination direction after being reflected by the second light-reflecting regions. The illumination beam includes the first light beams and the second light beams from the first illumination integrating element and the second illumination integrating element.

The illumination system in the projection system of embodiment of the invention includes a first illumination integrating element and a second illumination integrating element. The first illumination integrating element includes a plurality of first light-reflecting regions located on a first plane, and the second illumination integrating element includes a plurality of second light-reflecting regions located on a second plane. By the design that the second plane is not parallel to the first plane and the first/second light-reflecting regions are separated from each other, not only the manufacturing/production tolerance of the first/second illumination integrating elements are decreased, but also the optical quality of the illumination system is good, and thereby enabling good image quality of the projection system.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1 is a block diagram of the projection system according to an embodiment of the invention.

FIG. 2A is a schematic view illustrating the component architecture of an illumination system according to an embodiment of the invention.

FIG. 2B is a schematic view illustrating the component architecture of an illumination system according to another embodiment of the invention.

FIG. 2C is a schematic view illustrating the component architecture of an illumination system according to a further embodiment of the invention.

FIG. 2D is a schematic view illustrating the component architecture of an illumination system according to another embodiment of the invention.

FIG. 3 is a schematic view illustrating the assembly of the illumination integrating elements according to an embodiment of the invention.

FIG. 4 is a schematic exploded view of the illumination integrating elements according to an embodiment of the invention.

FIG. 5 is a schematic exploded view of the illumination integrating elements according to another embodiment of the invention

FIG. 6 is a schematic exploded view of the illumination integrating elements according to a further embodiment of the invention.

FIG. 7 is a schematic view of the assembled illumination integrating elements according to an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

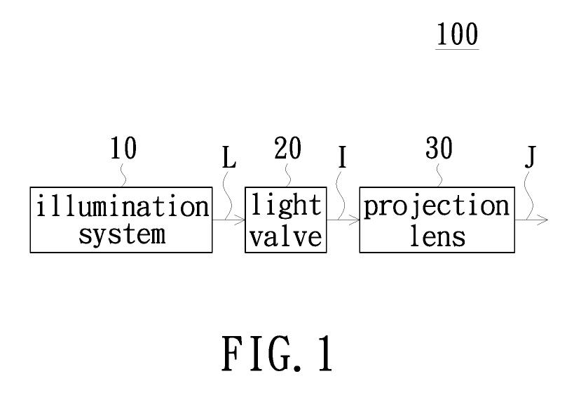

Referring to FIG. 1, the projection system 100 of an embodiment of the invention includes the illumination system 10, the light valve 20, and the projection lens 30. The illumination system 10 is adapted to provide an illumination beam L. The light valve 20 is located on the transmission path of the illumination beam L, and adapted to convert the illumination beam L to an image beam I. The projection lens 30 is located on the transmission path of the image beam I, and adapted to convert the image beam I into a projection beam J. In the embodiment, the light valve 20 may be a digital micromirror device (DMD), a liquid crystal on silicon (LCoS) panel or a liquid crystal display (LCD), but the invention is not limited thereto.

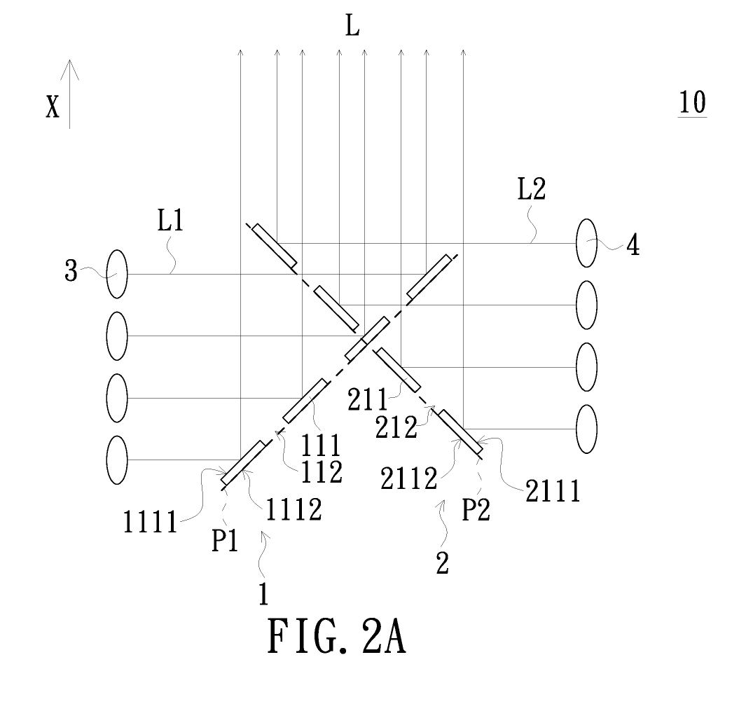

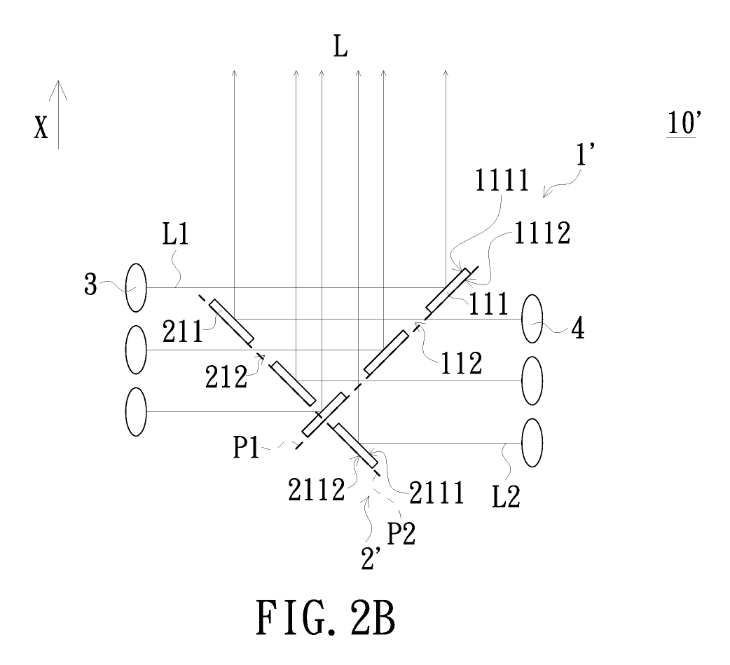

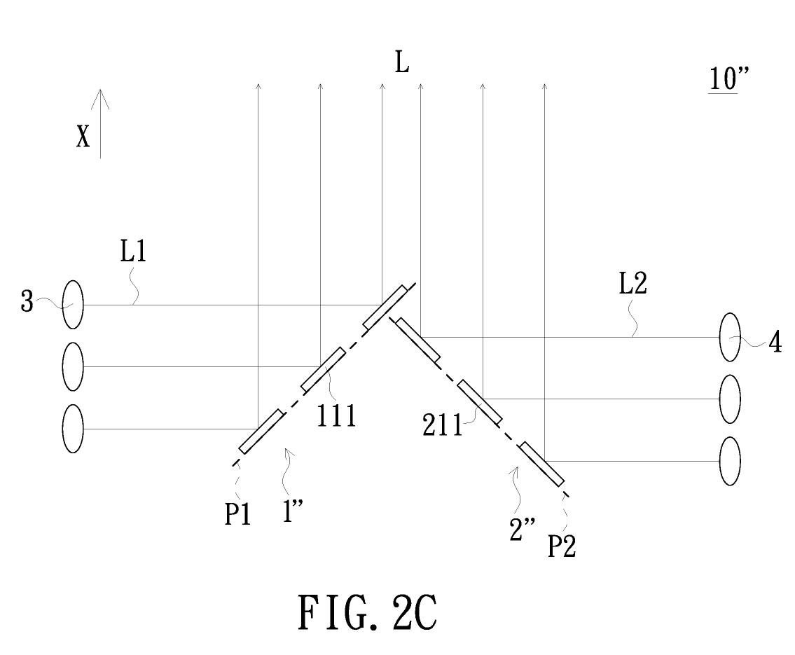

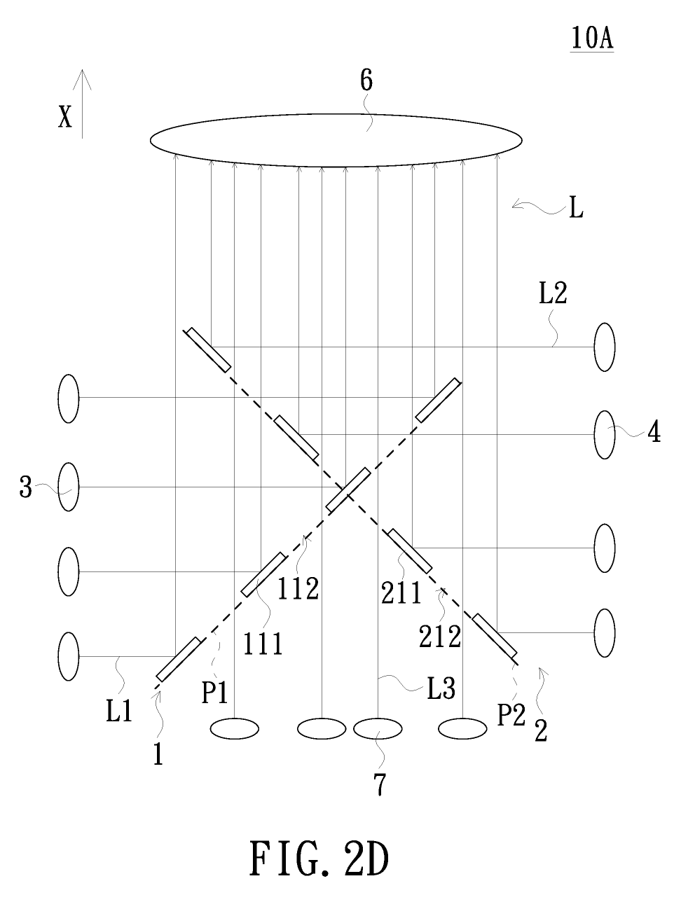

Embodiments of the illumination system 10 are shown in FIG. 2A through FIG. 2D to further illustrate the technical features of the embodiments of the invention. However, the embodiments are not intended to limit the scope of the invention. Referring to FIG. 2A, in the embodiment, the illumination system 10 includes a first illumination integrating element 1, a second illumination integrating element 2, a plurality of first light source elements 3, and a plurality of second light source elements 4. The first illumination integrating element 1 includes a plurality of first light-reflecting regions 111 separated from each other and located on the first plane P1. The second illumination integrating element 2 includes a plurality of second light-reflecting regions 211 separated from each other and located on the second plane P2. The second plane P2 is not parallel to the first plane P1. In the embodiment, the first light source elements 3 are adapted to respectively provide a plurality of first light beams L1, the first light-reflecting regions 111 are respectively and correspondingly located on the transmission path(s) of the first light beams L1, and the first light beams L1 are adapted to travel along the illumination direction X after being reflected by the first light-reflecting regions 111. In the embodiment, the second light source elements 4 are adapted to respectively provide a plurality of second light beams L2, the second light-reflecting regions 211 are respectively and correspondingly located on the transmission path(s) of the second light beams L2, and the second light beams L2 are adapted to travel along the illumination direction X after being reflected by the second light-reflecting regions 211. In the embodiment, the illumination beam L includes the first light beams L1 and the second light beams L2 from the first illumination integrating element 1 and the second illumination integrating element 2. In a more detailed description, the illumination beam L includes the first light beams L1 reflected by the first illumination integrating element 1 and the second light beams L2 reflected by the second illumination integrating element 2.

As shown in FIG. 2A, each of the first light-reflecting regions 111 has a first reflective surface 1111 and a first back surface 1112, and each of the second light-reflecting regions 211 has a second reflective surface 2111 and a second back surface 2112. In the embodiment, the first reflective surfaces 1111 and the first back surfaces 1112 are respectively located on opposite sides of the first plane P1, and the second reflective surfaces 2111 and the second back surfaces 2112 are respectively located on opposite sides of the second plane P2. In the embodiment, the first reflective surfaces 1111 and the second back surfaces 2112 faces toward the first light source elements 3 and faces away from the second light source elements 4, and the second reflective surfaces 2111 and the first back surfaces 1112 faces toward the second light source elements 4 and faces away from the first light source elements 3.

Furthermore, in the embodiment, the first illumination integrating element 1 further has a plurality of first light penetration regions 112, and the second illumination integrating element 2 further has a plurality of second light penetration regions 212. In the embodiment, each of the first light penetration regions 112 is disposed (sandwiched) between two adjacent the first light-reflecting regions 111, and each of the second light penetration regions 212 is disposed (sandwiched) between two adjacent the second light-reflecting regions 211.

As shown in FIG. 2A, in the embodiment, the first light beams L1 may be directly reflected by the first light-reflecting regions 111 of the first illumination integrating element 1 and then adapted to travel along the illumination direction X, and then adapted to penetrate through the second light penetration regions 212 of the second illumination integrating element 2; the first light beams L1 may also firstly penetrate through the second light penetration regions 212 of the second illumination integrating element 2, and then adapted to be reflected by the first light-reflecting regions 111 and then adapted to travel along the illumination direction X. In the embodiment, the second light beams L2 may also be directly reflected by the second light-reflecting regions 211 of the second illumination integrating element 2 to travel along the illumination direction X, and then adapted to penetrate through the first light penetration region(s) 112 of the first illumination integrating element 1; the second light beams L2 may also firstly penetrate through the first light penetration regions 112 of the first illumination integrating element 1, and then adapted to be reflected by the second light-reflecting regions 211 of the second illumination integrating element 2 to travel along the illumination direction X. In other words, in the embodiment, a portion of the first light beams L1 and the second light beams L2 may travel along the illumination direction X after respectively being reflected directly by the first light-reflecting regions 111 and the second light-reflecting regions 211, and then adapted to penetrate through the second light penetration regions 212 and the first light penetration regions 112; another portion of the first light beams L1 are adapted to penetrate through the second light penetration regions 212, and then adapted to travel along the illumination direction X after being reflected by the first light-reflecting regions 111 and; another portion of the second light beams L2 are adapted to penetrate through the first light penetration regions 112, and then adapted to travel along the illumination direction X after being reflected by the second light-reflecting regions 211.

However, the first illumination integrating element 1 and the second illumination integrating element 2 may also take other configurations relationship. For example, in the embodiment shown in FIG. 2B, all the first light beams L1 and all the second light beams L2 may firstly respectively pass through the second light penetration regions 212 of the second illumination integrating element 2 and the first light penetration regions 112 of the first illumination integrating element 1, and then adapted to be reflected by the first light-reflecting regions 111 of the first illumination integrating element 1 and the second light-reflecting regions 211 of the second illumination integrating element 2 to travel along the illumination direction X. Alternatively, in the embodiment indicated in FIG. 2C, for example, all of the first light beams L1 and second light beams L2 are, for example, directly reflected by the first light-reflecting regions 111 of the first illumination integrating element 1 and the second light-reflecting regions 211 of the second illumination integrating element 2 to travel along the illumination direction X. However, the configuration of the relative position of the first illumination integrating element 1 and the second illumination integrating element 2 and whether the beams firstly pass through the light penetration regions or are directly reflected by the light-reflecting regions may have different combination changes for a variety of application requirements.

Furthermore, as shown in FIGS. 2A to 2C, the first illumination integrating elements 1, 1′, and 1″ and the second illumination integrating elements 2, 2′, and 2″ of the illumination systems 10, 10′, and 10″ are respectively located on the first plane P1 and the second plane P2, and the first plane P1 and the second plane P2 are not parallel to the each other, e.g., in a cross state. In details, in the embodiment shown in FIG. 2A, the first illumination integrating element 1 and the second illumination integrating element 2 of the illumination system 10 cross each other and thus construct an X-shaped structure, and one of the first light-reflecting regions 111 is, e.g., disposed (sandwiched) between two adjacent second light-reflecting regions 211, i.e. one of the first light-reflecting regions 111 is disposed, e.g., in/within/through one of the second light penetration regions 212. In the embodiment as shown in FIG. 2B, the first illumination integrating element 1′ and the second illumination integrating element 2′ of the illumination system 10′ cross each other and thus construct a structure with an appearance a little near V-shaped or near asymmetric X-shaped, wherein one of the first light-reflecting regions 111 are disposed, e.g., between two second light-reflecting regions 211, i.e., one of the first light-reflecting regions 111 is disposed, for example, in/within/through one of the second light penetration regions 212. In the embodiment as shown in FIG. 2C, the first illumination integrating element 1″ and the second illumination integrating element 2″ of the illumination system 10″ do not cross each other to show a near-V-shaped structure, and none of the first light-reflecting regions 111, for example, is disposed (sandwiched) between two second light-reflecting regions 211, i.e., none of the first light-reflecting regions 111, for example, is disposed in/within/through any of the second light penetration regions 212. However, in the configuration shown in FIGS. 2A to 2C, the second light-reflecting regions 211 are, e.g., separated from the first light-reflecting regions 111; in other embodiments not shown in drawings, it is possible that at least one of the second light-reflecting regions 211 is connected to one of the first light-reflecting regions 111. For example, as shown in FIG. 2C, the one of the second light-reflecting regions 211 which is nearest/closest to the first illumination integrating element 1 may be connected to the one of the first light-reflecting regions 111 nearest/closest to the second illumination integrating element 2, so as to shorten the distance between the first illumination integrating element 1 and the second illumination integrating element 2, therefore reduce the illumination system 10″ in size, and thus the overall volume of the projection system 100 (depicted in FIG. 1) is reduced.

In the embodiment as shown in FIG. 2D, the illumination system 10A further includes a plurality of third light source elements 7, the third light source elements 7 are adapted to provide a plurality of third light beams L3 traveling along the illumination direction X. The first light-reflecting regions 111 and the second light-reflecting regions 211, e.g., are not located in transmission paths of the third light beams L3, and the third light beams L3 remain traveling along the illumination direction X after penetrating through, for example, the first light penetration regions 112 and the second light penetration regions 212. In the embodiment, the illumination beam L further includes the third light beams L3 from the first illumination integrating element 1 and the second illumination integrating element 2. In the embodiment, the illumination beam L includes not only the first light beams L1 from the first illumination integrating element 1 and the second light beams L2 from the second illumination integrating element 2, but also the third light beams L3 passing through the first light penetration regions 112 and the second light penetration regions 212, so as to enhance the brightness of the illumination system 10A, and thus increase the brightness and contrast of the projection image. In the embodiment, the first light source elements 3, the second light elements 4, and the third light source elements 7 may include but not limited to laser diodes or light emitting diodes.

Moreover, in the embodiment, the illumination system 10A may further include a light combiner element 6, and he light combiner element 6 is disposed on the transmission path of the illumination beam L. Specifically, in the embodiment, the light combiner element 6 is disposed on transmission paths of the first light beams L1, the second light beams L2, and the third beams L3 coining from the first illumination integrating element 1 and the second illumination integrating element 2. Furthermore, in the embodiment, the light valve 20 as shown in FIG. 1 is located on the transmission path of the illumination beam L from the light combiner element 6. However, the light combiner element 6 may also be disposed in the illumination systems 10, 10′, and 10″ shown in FIGS. 2A-2C, so as to receive the first light beams L1 and the second light beams L2 coming from the first illumination integrating element 1 and the second illumination integrating element 2.

In the embodiment, the first light source elements 3, the second light source elements 4, and the third light source elements 7 shown in FIGS. 2A-2D may be arranged in an array of light emitting diode or similar light emitting elements. In the embodiments shown in FIGS. 2A-2D, the position of the first light source elements 3 and the second light source elements 4 disposed at is opposed to each other, so that the angle between the projecting directions of the first light beams L1 and the second light beams L2 is substantially 180 degrees, but the angle is not intended to limit the invention, and a variety of angles may be determined depending on the needs of a variety of applications.

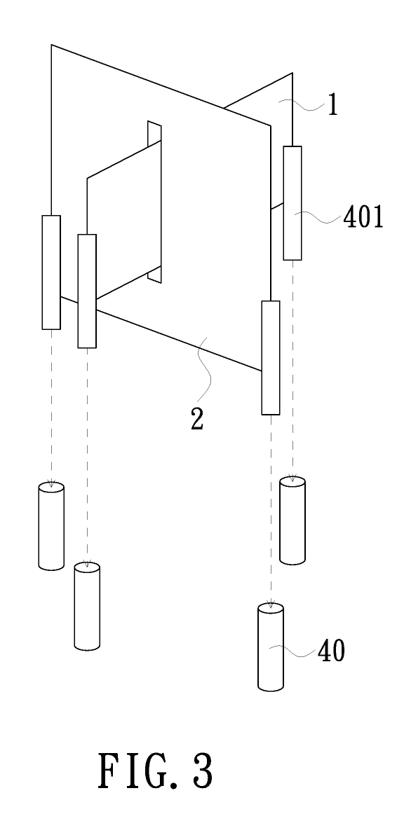

As shown in FIG. 3, in the embodiment, the projection system 100 may further include an optical engine housing (not shown), and the first illumination integrating element 1 and the second illumination integrating element 2 are fixed to the optical engine housing. In the embodiment, the projection system 100 may further at least one fixing member 401. For simplifying the descriptions, in the embodiment, the optical engine housing, e.g., is represented by the fixing base 40, but is not to limit the invention. The first illumination integrating element 1 and the second illumination integrating element 2 may be fixed to the optical engine housing by a plurality of fixing members 401 (the four fixing members for example as shown in FIG. 3) corresponding to the fixing base 40 in the embodiment. However, the fixing manner and the fixing structure of the first illumination integrating element 1 and the second illumination integrating element 2 illustrated in FIG. 3 are only illustrative examples, and appropriate fixations, fixing manners or fixing structures may be adapted according to needs for variety of different applications.

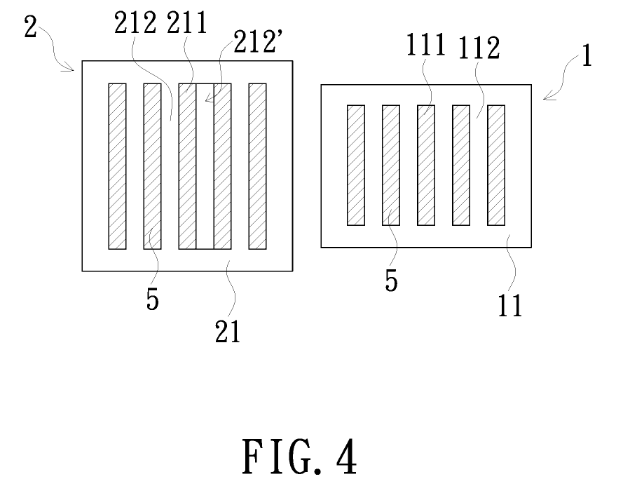

Regarding the X-shaped cross structures shown in FIG. 2A, 2D, and FIG. 3, more detailed descriptions for different structures and combinations of the illumination integrating elements of the embodiments of the invention are illustrated in FIGS. 4 to 6. Refer to FIG. 4, in the embodiment, the first illumination integrating element 1 includes a first substrate 11, wherein the first light-reflecting regions 111 are, for example, a plurality of strip-like reflective films 5 disposed on the first substrate 11, and the reflective films 5 are arranged e.g. as an one-dimensional array. Furthermore, in the embodiment, the reflective films 5 of the first illumination integrating element 1 are separated from each other to from a plurality of the first light penetration regions 112, i.e. each of the first light penetration regions 112 is disposed (sandwiched) between two adjacent reflective films 5. In the embodiment, the second illumination integrating element 2 includes a second substrate 21, wherein the second light-reflecting regions 211, for example, are a plurality of strip-like reflective films 5 disposed on the second substrate 21, and the reflective films 5 are arranged, e.g., as an one-dimensional array. Furthermore, in the embodiment, the reflective films 5 of the second illumination integrating element 2, are separated from each other and thus form a plurality of second light penetration regions 212, i.e. each of the second light penetration regions 212 is disposed (sandwiched) between two adjacent reflective films 5. In the embodiment, in order to construct two illumination integrating elements to exhibit X-shaped cross structures as illustrated in FIGS. 2A, 2D and 3, as shown in FIG. 4, the size (e.g., width) of the second substrate 21 may substantially larger than the size (e.g., width) of the first substrate 11, and one of the second light penetration regions 212 disposed on the second substrate 21 is hollowed to form the hollowed region 212′, so that the first substrate 11 may penetrate through the hollowed region 212′ of the second substrate 21 and form an X-shaped cross structure, and then the fixing members 40 as shown in FIG. 3 may be used to fix to the optical engine housing (not shown).

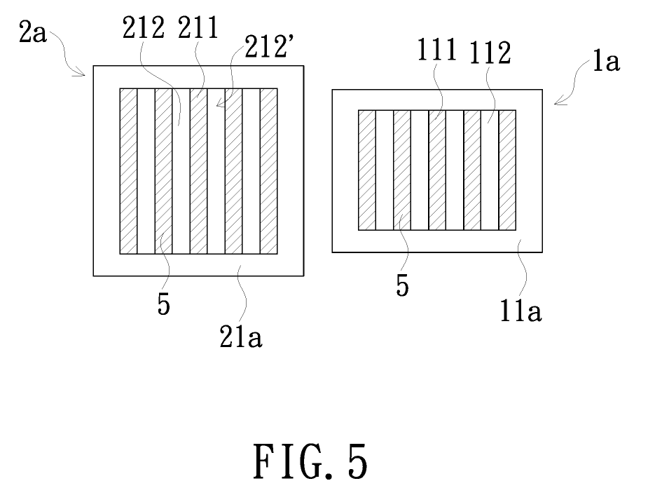

As shown in FIG. 5, the first illumination integrating element 1a and the second illumination integrating element 2a of the embodiment are similar to the first illumination integrating element 1 and the second illumination integrating element 2 as shown in FIG. 4, and the main difference between the two embodiments is that the first light penetration regions 112 are formed, e.g., through hollowing out the first substrate 11a and the second light penetration regions are formed, e.g., through hollowing out the second substrate 21a in the embodiment.

Moreover, in the embodiments shown in FIG. 4 and FIG. 5, for example, the first substrate 11/11a and the second substrate 21/21a are made of transparent material(s), and the reflective films 5 are formed, as indicated in FIG. 2A, at the first reflective surface 1111 and the second reflective surface 2111. In the embodiment shown in FIG. 4, for example, the reflective films 5 are formed only at the first light-reflecting regions 111 of the first substrate 1 and the second light-reflecting regions 211 of the second substrate 21. In the embodiment shown in FIG. 5, for example, the reflective films 5 are formed on the entire pieces of the first substrate 11a and the second substrate 21a, and then the positions of the first light penetration regions 112 of the first substrate 11a and the second light penetration regions 212 of the second substrate 21a disposed at are hollowed, and the first light-reflecting regions 111 and the second light-reflecting regions 211 are formed accordingly.

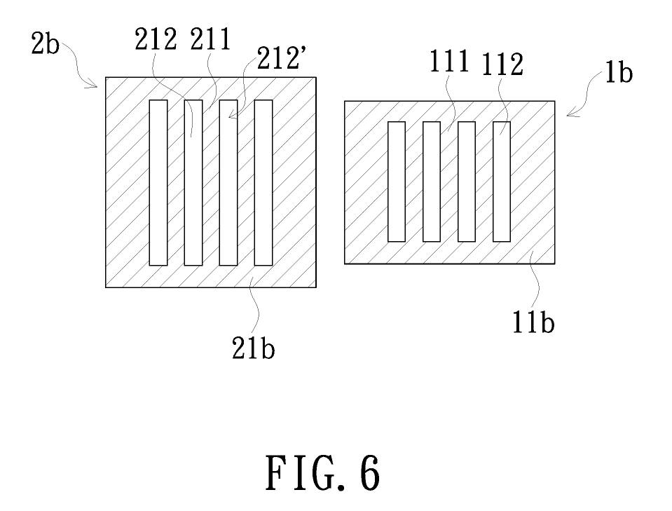

As shown in FIG. 6, the first illumination integrating element 1b and the second illumination integrating element 2b of the embodiment are similar to the first illumination integrating element 1a and the second illumination integrating element 2b as shown in FIG. 5, and the main difference between the two embodiments is that, in the embodiment, the first substrate 11b of the first illumination integrating element 1b and the second substrate 21b of the second illumination integrating element 2b are, for example, made of reflective material(s), such as metal(s), but the invention is not limited thereto. Since the first reflective surfaces 1111 and the second reflecting surfaces 2111 have light-reflective functions, thus no additional plating/coating process is needed to form the reflective films 5 as shown in FIGS. 4 and 5, and the manufacturing process is then simplified. In addition, like the embodiment shown in FIG. 5, in the embodiment shown in FIG. 6, the first light penetration regions 112 are, for example, formed by hollowing out the first substrate 11b, and the second light penetration regions 212 are, for example, formed by hollowing out the second substrate 21b.

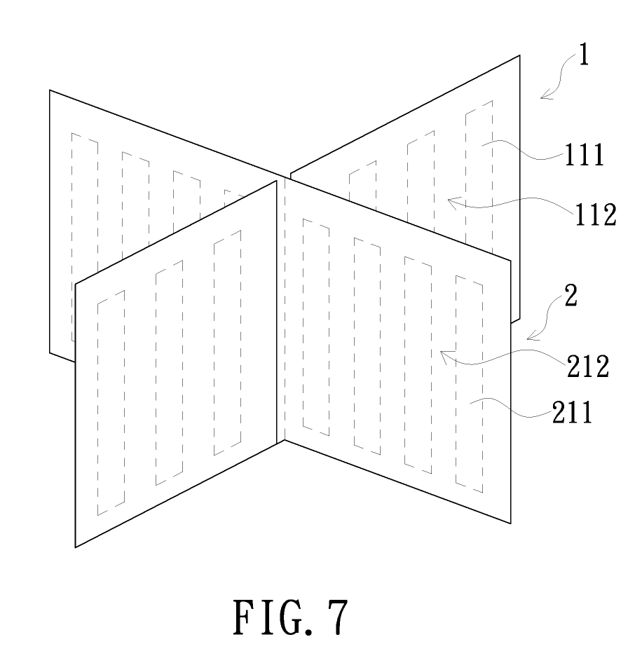

However, the X-shaped cross structures shown in FIG. 2A, FIG. 2D and FIG. 3, and the first illumination integrating elements 1/1a/1b and the second illumination integrating elements 2/2a/2b construct the X-shaped cross structure by using the first substrates 11/11a/11b to penetrate through the second substrates 21/21a/21b shown in FIG. 4 to FIG. 6, are only illustrative examples and are not intended to limit the invention. In addition to the aforementioned penetrated/drilled structures, as shown in FIG. 7, the first illumination integrating element 1 and the second illumination integrating element 2 may also be formed by integrating, jointing or splicing pieces. In other embodiments not shown in the drawings, the X-shaped structures may be formed by blocking, embedding or engagement of pieces and the like. Because the X-shaped structures are not formed by penetrating through the two substrates to each other, the first illumination integrating element 1 and the second illumination integrating element 2 may have the same size (in such as length or width). Furthermore, in order to form the X-shaped cross structures shown in FIG. 2A, FIG. 2D, FIG. 3 and FIG. 7, in the embodiment, the first substrates 11,11a, 11b shown in FIGS. 4-6 may be disposed (located) on the first plane P1 shown in FIG. 2A and FIG. 2D and the second substrates 21, 21a, 21b shown in FIGS. 4-6 may be disposed (located) on the second plane P2 shown in FIG. 2A and FIG. 2D.

In summary, the embodiment of the projection system of the invention includes an illumination system having first and second illumination integrating elements, the first illumination integrating element includes a plurality of first light-reflecting regions disposed on a first plane, and the second illumination integrating element includes a plurality of second light-reflecting regions disposed on a second plane. By the design that the second plane is not parallel to the first plane and the first/second light-reflecting regions are separated from each other, not only the manufacturing/production tolerance of the first/second illumination integrating elements is lower, but also the optical quality of the illumination system is good, thereby enables a good image quality of the projection system. In the embodiments of the invention, by using two illumination integrating elements arranged not parallel to each other, interferes among the light beams emitted by the light source elements of the illumination system of the projection system are avoided. Accordingly, in the embodiments of the invention, the illumination system may have good optical quality and the projection system may have good image quality. Further, since the first illumination integrating element and the second illumination integrating element of the embodiments of the invention are easier to be manufactured, therefore there may/will be advantages such as lower production costs and smaller manufacturing/production tolerances.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A projection system, comprising;
an illumination system, adapted to provide an illumination beam, wherein the illumination system comprises;
a first illumination integrating element, having a plurality of first light-reflecting regions, wherein the first light-reflecting regions are separated from each other and located on a first plane;
a second illumination integrating element, having a plurality of second light-reflecting regions, wherein the second light-reflecting regions are separated from each other and located on a second plane, and the second plane is not parallel to the first plane;
a plurality of first light source elements, adapted to respectively provide a plurality of first light beams, wherein the first light-reflecting regions are located on a transmission path of the first light beams, and the first light beams are adapted to travel along an illumination direction after being reflected by the first light-reflecting regions; and
a plurality of second light source elements, adapted to respectively provide a plurality of second light beams, wherein the second light-reflecting regions are located on a transmission path of the second light beams, and the second light beams are adapted to travel along the illumination direction after being reflected by the second light-reflecting regions, and the illumination beam comprises the first light beams and the second light beams from the first illumination integrating element and the second illumination integrating element;
a light valve, located on a transmission path of the illumination beam, and adapted to convert the illumination beam into an image beam; and
a projection lens, located on a transmission path of the image beam.

2. The projection system according to claim 1, wherein each of the first light-reflecting regions has a first reflective surface and a first back surface, each of the second light-reflecting regions has a second reflective surface and a second back surface, the first reflective surfaces and the first back surfaces are located on two opposite sides of the first plane, the second reflective surfaces and the second back surfaces are located on two opposite sides of the second plane, the first reflective surfaces and the second back surfaces face toward the first light source elements and face away from the second light source elements, and the second reflective surfaces and the first back surfaces face toward the second light source elements and face away from the first light source elements.

3. The projection system according to claim 1, wherein the first illumination integrating element has a plurality of first light penetration regions, the second illumination integrating element has a plurality of second light penetration regions, each of the first light penetration regions is disposed between the two adjacent first light-reflecting regions, and each of the second light penetration regions is disposed between the two adjacent second light-reflecting regions.

4. The projection system according to claim 3, wherein the first light beams are adapted to penetrate through the second light penetration regions, then are adapted to be reflected by the first light-reflecting regions, wherein the second light beams are adapted to penetrate through the first light penetration regions, and then are adapted to be reflected by the second light-reflecting regions.

5. The projection system according to claim 3, wherein the first light beams are adapted to be reflected by the first light-reflecting regions, and then are adapted to penetrate through the second light penetration regions, wherein the second light beams are adapted to be reflected by the second light-reflecting regions, and then are adapted to penetrate through the first light penetration regions.

6. The projection system according to claim 1, wherein the illumination system further comprises:
a plurality of third light source elements, adapted to respectively provide a plurality of third light beams traveling along the illumination direction, wherein the first light-reflecting regions and the second light-reflecting regions are not located on a transmission path of the third light beams, the third light beams are adapted to remain traveling along the illumination direction after penetrating through the first light penetration regions and the second light penetration regions, and the illumination beam further comprises the third light beams from the first illumination integrating element and the second illumination integrating element.

7. The projection system according to claim 1, wherein the first illumination integrating element comprises:
a first substrate, located on the first plane, wherein the first light-reflecting regions are a plurality of reflective films, and the reflective films are disposed on the first substrate.

8. The projection system according to claim 7, wherein the first illumination integrating element has a plurality of first light penetration regions, each of the first light penetration regions is disposed between the two adjacent reflective films.

9. The projection system according to claim 1, wherein the second illumination integrating element comprises:
a second substrate, located on the second plane, wherein the second light-reflecting regions are a plurality of reflective films, and the reflective films are disposed on the second substrate.

10. The projection system according to claim 9, wherein the second illumination integrating element has a plurality of second light penetration regions, each of the second light penetration regions is disposed between the two adjacent reflective films.

11. The projection system according to claim 1, wherein one of the first light-reflecting regions is disposed between two of the second light-reflecting regions.

12. The projection system according to claim 1, wherein the second light-reflecting regions are separated from the first light-reflecting regions, or at least one of the second light-reflecting regions is connected to one of the first light-reflecting regions.

13. The projection system according to claim 1, wherein the illumination system further comprises:
a light combiner element, disposed on a transmission path of the first light beams and the second light beams from the first illumination integrating element and the second illumination integrating element, wherein the light valve is located on the transmission path of the illumination beam from the light combiner element.

14. The projection system according to claim 1, further comprises an optical engine housing, wherein the first illumination integrating element and the second illumination integrating element are fixed to the optical engine housing.

15. An illumination system, adapted to provide an illumination beam, the illumination system comprises:
a first illumination integrating element, having a plurality of first light-reflecting regions, wherein the first light-reflecting regions are separated from each other and located on a first plane;
a second illumination integrating element, having a plurality of second light-reflecting regions, wherein the second light-reflecting regions are separated from each other and located on a second plane, and the second plane is not parallel to the first plane;
a plurality of first light source elements, adapted to respectively provide a plurality of first light beams, wherein the first light-reflecting regions are located on a transmission path of the first light beams, and the first light beams are adapted to travel along an illumination direction after being reflected by the first light-reflecting regions; and
a plurality of second light source elements, adapted to respectively provide a plurality of second light beams, wherein the second light-reflecting regions are located on a transmission path of the second light beams, and the second light beams are adapted to travel along the illumination direction after being reflected by the second light-reflecting regions, and the illumination beam comprises the first light beams and the second light beams from the first illumination integrating element and the second illumination integrating element.

16. The illumination system according to claim 15, wherein each of the first light-reflecting regions has a first reflective surface and a first back surface, each of the second light-reflecting regions has a second reflective surface and a second back surface, the first reflective surfaces and the first back surfaces are located on two opposite sides of the first plane, the second reflective surfaces and the second back surfaces are located on two opposite sides of the second plane, the first reflective surfaces and the second back surfaces face toward the first light source elements and face away from the second light source elements, and the second reflective surfaces and the first back surfaces face toward the second light source elements and face away from the first light source elements.

17. The illumination system according to claim 15, wherein the first illumination integrating element has a plurality of first light penetration regions, the second illumination integrating element has a plurality of second light penetration regions, each of the first light penetration regions is disposed between the two adjacent first light-reflecting regions, and each of the second light penetration regions is disposed between the two adjacent second light-reflecting regions.

18. The illumination system according to in claim 17, wherein the first light beams are adapted to penetrate through the second light penetration regions, then are adapted to be reflected by the first light-reflecting regions, wherein the second light beams are adapted to penetrate through the first light penetration regions, and then are adapted to be reflected by the second light-reflecting regions.

19. The illumination system according to in claim 17, wherein the first light beams are adapted to be reflected by the first light-reflecting regions, and then are adapted to penetrate through the second light penetration regions, wherein the second light beams are adapted to be reflected by the second light-reflecting regions, and then are adapted to penetrate through the first light penetration regions.

20. The illumination system according to claim 15, further comprising:
a plurality of third light source elements, adapted to respectively provide a plurality of third light beams traveling along the illumination direction, wherein the first light-reflecting regions and the second light-reflecting regions are not located on a transmission path of the third light beams, the third light beams are adapted to remain traveling along the illumination direction after penetrating through the first light penetration regions and the second light penetration regions, and the illumination beam further comprises the third light beams from the first illumination integrating element and the second illumination integrating element.

21. The illumination system according to claim 15, wherein the first illumination integrating element comprises:
a first substrate, located on the first plane, wherein the first light-reflecting regions are a plurality of reflective films, and the reflective films are disposed on the first substrate.

22. The illumination system according to claim 21, wherein the first illumination integrating element has a plurality of first light penetration regions, each of the first light penetration regions is disposed between the two adjacent reflective films.

23. The illumination system according to claim 15, wherein the second illumination integrating element comprises:
a second substrate, located on the second plane, wherein the second light-reflecting regions are a plurality of reflective films, and the reflective films are disposed on the second substrate.

24. The illumination system according to claim 23, wherein the second illumination integrating element has a plurality of second light penetration regions, each of the second light penetration regions is disposed between the two adjacent reflective films.

25. The illumination system according to claim 15, wherein one of the first light-reflecting regions is disposed between two of the second light-reflecting regions.

26. The illumination system according to claim 15, wherein the second light-reflecting regions are separated from the first light-reflecting regions, or at least one of the second light-reflecting regions is connected to one of the first light-reflecting regions.

27. The illumination system 15 according to claim, further comprising:
a light combiner element, disposed on a transmission path of the first light beams and the second light beams from the first illumination integrating element and the second illumination integrating element.
